(19) United States
(12) Patent Application Publication
(10) Pub. No.: US 2017/0306173 A1
(43) Pub. Date: Oct. 26, 2017

(54) PRINTABLE FERROELECTRIC INK

(71) Applicants: Henkel AG & Co. KGaA, Duusseldorf (DE); Henkel IP & Holding GmbH, Duesseldorf (DE)

(72) Inventors: Jose Garcia-Miralles, Duesseldorf (DE); Fouad Salhi, Farmington, CT (US); Jaime Rodriquez Lopez, Madrid (ES); Jorge Lima Garcia, Brussels (BE); Beatriz Pina-Romero, Duesseldorf (DE); Paz Carreras Segui, Barcelona (ES); Jorge Marquet Cortes, Barcelona (ES); Rosa Maria Sebastian Perez, Barcelona (ES); Julen Mendizabal Zalacain, Barcelona (ES)

(21) Appl. No.: 15/626,247

(22) Filed: Jun. 19, 2017

Related U.S. Application Data
(63) Continuation of application No. PCT/EP2015/080128, filed on Dec. 17, 2015.
(60) Provisional application No. 62/093,114, filed on Dec. 17, 2014.
(60) Provisional application No. 62/196,383, filed on Jul. 24, 2015.

(51) Int. Cl. C09D 11/52; C09D 11/10; C09D 11/033

(52) U.S. Cl. CPC C09D 11/52; C09D 11/033; C09D 11/10

(57) ABSTRACT

The present invention relates to a printable ferroelectric ink composition comprising a binder, an organic ferroelectric component and a solvent, and wherein said ferroelectric component is in the ferroelectric phase. The ferroelectric ink composition according to the present invention can be used as a sensor, an emitter or as a generator in an energy harvester. Furthermore, the present invention also encompasses a device comprising a ferroelectric ink composition according to the present invention between two conductive elements.

### TECHNICAL FIELD

The present invention relates to a printable ferroelectric ink composition. The composition according to the present invention has adhesive properties while maintaining good ferroelectric response.

### BACKGROUND OF THE INVENTION

Currently, applications in which ferroelectric materials are required use ferroelectric ceramics or ferroelectric polymers. The latter show very low adhesive properties, while the former have no adhesion at all. Therefore, if these materials have to be fixed permanently to any substrate, they have to be attached using an adhesive layer.

For example, ferroelectric ceramics have been mixed with polymeric resins resulting in composite materials. This approach is widely used and very well known, nevertheless, the polymeric resin is not used due to its adhesive properties but rather its binding properties. By doing this, the mechanical properties (too brittle) and the processability of the ferroelectric systems (difficult to process in general) are improved.

For example an epoxy resin has been used as a binder in PZT/epoxy piezoelectric paints. These composites are processed into films, which are then attached by one side in order to act like piezoelectric sensors in NDT applications, where vibration detection is required.

Alternatively, polymeric coatings using specific fluoropolymers as part of the composition have been developed. However, in these compositions, the fluoropolymers are not used due their ferroelectric properties but their chemical resistance properties. And therefore, fluoropolymers are not in the ferroelectric phase in these coating compositions. It is well known that fluoropolymer-based ferroelectric polymers have dielectric properties, but also outstanding barrier properties. Those come from their chemical nature, making them very inert materials. Nevertheless, this property hinders the adhesion to the substrates, and in order to fulfil the coating requirements, it is necessary to incorporate an alternative resin to improve adhesion properties.

Printable non-ferroelectric polymer inks have been used in force sensing resistors. The force sensing resistors (FSR), are devices comprising robust polymer thick film (PTF) that exhibit decrease in resistance with increase in force applied to the surface of the sensor. This force sensitivity is optimized for use in human touch control of electronic devices such as automotive electronics, medical systems, industrial applications and robotic applications. This effect is provided by using conductive inks in combination with non-conductive inks. When force is applied, a range of resistance values is generated, which can be translated into a measured force.

Therefore, there is a need for a printable ferroelectric ink composition, which adheres to the substrate on its own without using separate adhesive to adhere it, while providing good ferroelectric response.

### SUMMARY OF THE INVENTION

The present invention relates to a ferroelectric ink composition comprising a) a binder, b) an organic ferroelectric component, c) a solvent, and wherein said ferroelectric component is in a ferroelectric phase.

In addition, the present invention relates to use of a ferroelectric ink composition according to the present invention as a printable ink.

The present invention also encompasses use of a ferroelectric ink composition according to the present invention as a sensor, an emitter or as a generator in an energy harvester.

Furthermore, the present invention also encompasses a device comprising a ferroelectric adhesive ink composition according to the present invention between two conductive elements.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps.

The recitation of numerical end points includes all numbers and fractions subsumed within the respective ranges, as well as the recited end points.

When an amount, a concentration or other values or parameters is/are expressed in form of a range, a preferable range, or a preferable upper limit value and a preferable lower limit value, it should be understood as that any ranges obtained by combining any upper limit or preferable value with any lower limit or preferable value are specifically disclosed, without considering whether the obtained ranges are clearly mentioned in the context.

All references cited in the present specification are hereby incorporated by reference in their entirety.

Unless otherwise defined, all terms used in the disclosing the invention, including technical and scientific terms, have the meaning as commonly understood by one of the ordinary skill in the art to which this invention belongs to. By means of further guidance, term definitions are included to better appreciate the teaching of the present invention.

The present invention provides printable inks, which are provided with ferroelectric properties. Ferroelectric-adhesion system is simplified in a single material (ink), and therefore, interfaces and defects are minimized. An ink with ferroelectric properties will simplify the system and will improve its quality since interfaces, which are mechanically weak regions and source of defects, will be avoided.

The printable inks according to the present invention can be used as alternative approach to detect the force versus the current inks comprising a mixture of conductive inks and non-conductive inks. The printable inks according to the present invention are suitable for use in the force sensing resistors without need for a separate power source.

The present invention provides a ferroelectric ink composition comprising a) a binder, b) an organic ferroelectric component, c) a solvent, and wherein said ferroelectric component is in a ferroelectric phase.

Each of the essential components of the ferroelectric ink composition according to the present invention are described in details below.

### A binder

A ferroelectric ink composition according present invention comprises a binder. The binder used in the ferroelectric ink composition may be selected from any binder currently used in the industry (printable inks).

In general, a binder is selected from the group consisting of thermoplastic polyurethanes, polyesters, polyacrylates, polysiloxanes, halogenated vinyl or vinylidene polymers, polyamide copolymers, phenoxy resins, polyethers, polyketones, polyvinyl butyral, polyvinyl pyrrolidone, polyacrylates, polycyanoacrylates and mixtures thereof, preferably, said binder selected from the group consisting of thermoplastic polyurethanes, phenoxy resins and mixtures thereof.

The thermoplastic polyurethanes are preferred binders because they provide good adhesion and flexibility and they do not interfere with the mechanical integrity of the film. A phenoxy resins are also preferred binders, due to the high Tg range and being harder and more robust, and therefore, providing ideal mechanical properties.

Suitable binder for use in the present invention can be a homo- or copolymer. Suitable monomers from which the binder can be built up comprise vinylaromatic monomers, such as alpha-methyl styrene and styrene, acrylonitrile, methacrylonitrile, acrylamide, vinyl acetate, vinyl chloride, phenoxyethyl acrylate, cyanoacrylates such as ethyl-2-cyanoacrylate, n-butyl cyanoacrylate, 2-octyl cyanoacrylate, methyl 2-cyanoacrylate, β-methoxyethyl cyanoacrylate, multifunctional acrylates, such as hexanedioldimethyl acrylate, glycoldimethyl acrylate, divinyl benzene and esters of methacrylic acid or acrylic acid, or mixtures of these esters. Examples of suitable esters comprise alkyl esters, where the alkyl group may contain from 1 to 20 carbon atoms, alkoxyalkyl esters, such as butoxyethyl acrylate and butoxyalkyl methacrylate, and hydroxyalkyl esters. Other suitable monomers are acid monomers such as acrylic acid, methacrylic acid, maleic acid, dimethyl terephthalate, fumaric acid, crotonic acid, itaconic acid, aconitic acid and semi-esters thereof, and maleic acid anhydride and the like, monomers containing fluorine, such as vinylidene fluoride, hexafluoropropylene and tetrafluoroethylene, polyols, such as ethylene glycol and propylene glycol, and polyisocyanates, such as 2,4-toluene diisocyanate and hexamethylene diisocyanate.

Suitable commercially available binder material to be used in the present invention are for example Estane 5715 from Lubrizol and PKHB, PKHJ and PKHC from Inchem.

A ferroelectric ink composition according to the present invention comprises a binder from 1% to 20% by weight of the total weight of the composition, preferably from 1.2% to 15%, and more preferably from 1.5% to 13.5%.

The binder quantity in the composition according to the present invention is ideal, because higher quantities would interfere negatively with the ferroelectric properties leading to composition having very poor ferroelectric response or no ferroelectric response at all. In addition, lower levels (less than 1.0% by weight of the total weight of the composition) would decrease adhesion properties of the ferroelectric ink composition.

### An Organic Ferroelectric Component

A ferroelectric ink composition according to the present invention comprises an organic ferroelectric component in the ferroelectric phase.

By the term “ferroelectric phase” is meant here in a material, which contains a certain amount of crystalline phase, which is in a specific symmetry, and which is responsible of providing ferroelectric response.

The skilled person knows how to determine whether the component is in the ferroelectric phase or not by doing standard measurements by using x-ray diffraction or differential scanning calorimetry (DSC) or Fourier-transformed infra-red (FTIR). Alternatively, ferroelectric phase can be determined by measuring the ferroelectric response of the material. Meaning that if the composition is not in the ferroelectric phase, there will not be ferroelectric response either.

Suitable organic ferroelectric components for use in the present invention show a Tc between 110° C. and 170° C., preferably between 110° C. and 140° C. Type and quantity of the ferroelectric component effect on the ferroelectric response of the ink composition.

Suitable organic ferroelectric component for use in the present invention is selected from the group consisting of polyvinylidene difluoride (PVDF), polyvinylidene difluoride trifluoroethylene (P(VDF-TrFE)), polyvinylidene difluoride hexafluoropropylene (P(VDF-HFP)), polyvinylidene difluoride trifluoroethylene chlorofluoroethylene (P(VDF-TrFE-CFE)) 2-methylbenzimidazole, diisopropylammonium chloride, diisopropylammonium bromide, croconic acid, TTF-PMDI salts and mixtures thereof, preferably said ferroelectric component is polyvinylidene difluoride trifluoroethylene (P(VDF-TrFE)).

Polyvinylidene difluoride trifluoroethylene (P(VDF-TrFE)) is preferred ferroelectric component because it grows in the desired crystal phase easily, and subsequently, the polymer blends are ferroelectric by default.

A ferroelectric ink composition according to the present invention comprises an organic ferroelectric component from 10% to 50% by weight of the total weight of the composition, preferably from 12% to 45%, and more preferably from 12.5% to 40%.

If the quantity of the ferroelectric component is too high, the adhesion properties of the ferroelectric ink composition will decrease. On the other hand too low quantity of the ferroelectric component will lead to poor ferroelectric response or no ferroelectric response at all.

### Solvent

A ferroelectric ink composition according present invention comprises a solvent. A wide variety of known organic solvents can be used in the present invention. Suitable solvents to be used in the present invention preferably have a flashpoint high enough to make the ink screen printable without the ink drying on the screen. Preferably, the flash point of the solvent is from 60 to 120° C.

Furthermore, the solvent that can be used for the ferroelectric ink composition according to the present invention is selected on the basis of the solubility of the binder to be used and the manner in which the ink is to be applied to a substrate. As regards the manner in which the ink is applied onto a substrate, particularly the viscosity of the ink is of importance. One of the factors influencing the viscosity is the solvent. Further, the compatibility of the substrate to which the ink is to be applied, with the solvent plays a part.

Suitable solvent for use in the present invention can be selected from the group consisting of alcohols, ketones, esters, glycol esters, glycol ethers, ethers, amides, organosulfur compounds and mixtures thereof.

Preferably, said solvent is selected from the group consisting of acetone, amyl acetate, ethyl 3-ethoxypropionate (EEP, Eastman), diethyl glycol, monoethyl ether, diethylene glycol dimethylene ether, carbitol, carbitol acetate, butyl carbitol, methyl ethyl ketone (MEK), cyclohexanone, diethylene glycol monoethyl ether acetate, ethylene glycol monobutyl ether acetate, ethylene glycol monobutyl ether, dipropylene glycol monomethyl ether, dipropylene glycol dimethyl ether, mixture of dimethyl glutarate and dimethyl succinate (DBE-9), N,N-dimethylformamide, dimethylacetamide, dimethylsulfoxide, water, ethanol and mixtures thereof. More preferably said solvent is selected from the group consisting of acetone, mixture of dimethyl glutarate and dimethyl succinate (DBE-9), ethylene glycol monobutyl ether acetate, methylethyl ketone (MEK) and mixtures thereof.

Fluoropolymers forming a ferroelectric component are very inert, and therefore, hard to dissolve. Preferred solvents provide best solubility, and therefore, provide improved homogeneity of the ink composition.

Suitable commercially available solvents to be used in the present invention are for example DBE-9 from Sigma-Aldrich.

A ferroelectric ink composition according to the present invention comprises a solvent from 20% to 85% by weight of the total weight of the composition, preferably from 30% to 85%, and more preferably from 34% to 85%.

Ideal quantity of the solvent in the ferroelectric ink composition according to the present invention depends on the application. For example, if the ink is used in the screen printing, the solvent level is higher in order to gain ideal viscosity for the screen printing. Although, if the solvent quantity is too high, the solid content of the composition is too low. On the other hand, if the solvent quantity is too low, this will have negative impact on composition formation and formation of homogenous film.

### Optional Ingredients

In addition to above mentioned ingredients a ferroelectric ink composition according to the present invention may further comprise additional ingredients. Additional ingredients may be included in the ferroelectric ink composition to provide desired properties. Various additives typically used in the ink compositions, and which may be used in the ferroelectric ink compositions according to the present invention include surface active agents, surfactants, wetting agents, antioxidants, thixotropy agents, reinforcement fibers, silane functional perfluoroether, phosphate functional perfluoroether, titanates, waxes, phenol formaldehyde, air release agents, flow additives, adhesion promoters, rheology modifiers, and spacer beads. The optional ingredients are specifically chosen to obtain the desired balance of properties for the use of the binders utilized in the ferroelectric ink compositions according to the present invention.

When present, the ferroelectric ink composition may comprise optional ingredients up to about 10% by weight of the total weight of the composition.

Preferably, the ferroelectric ink composition according to the present invention has a viscosity from 1 to 30 Pas (10 s⁻¹) measured on a rheometer AR 2000 at constant shear rate with 40 mm plate-plate configuration (0.5 mm gap, 180 sec, at 25° C.), preferably from 2 to 25 Pas (10 s⁻¹) and more preferably from 3 to 20 Pas (10 s⁻¹).

Preferably, the ferroelectric ink composition according to the present invention has a thixotropic index from 1 to 15, preferably from 1 to 8 and more preferably from 1 to 4. The thixotropic index is calculated by dividing the viscosity at 1.5 s⁻¹ by viscosity at 15 s⁻¹.

Preferably, the ferroelectric ink composition according to the present invention has a permanent remnant polarisation value (Pr) equal or greater than 1.0 μC/cm² measured according to the test method described in the examples section below, preferably equal or greater than 1.1 μC/cm². In highly preferred embodiment, the permanent remnant polarisation value (Pr) is from 1.2 μC/cm² to 10.0 μC/cm², preferably from 1.2 μC/cm² to 6.0 μC/cm².

Preferably, the ferroelectric ink composition according to the present invention has a piezoelectric strain coefficient d₃₃ equal or greater than 3.0 pC/N measured according to the test method described in the examples section below, preferably equal or greater than 3.5 pC/N. In highly preferred embodiment, d₃₃ coefficient is from 3.8 pC/N to 20.0 pC/N, preferably from 3.8 pC/N to 15.8 pC/N.

Preferably, the ferroelectric ink composition according to the present invention has a solid content from 5% to 35%, preferably from 10% to 30% and more preferably from 15% to 25%.

Ideal solid content provides ideal coverage for the substrate and provides ideal film thickness. Furthermore, ideal solid content has also positive impact on the ferroelectric response.

The ferroelectric ink composition according to the present invention is in the form of an ink or a screen printable ink, however, it also may be in the form of a film or a laminate. Preferably, the composition is in the form of an ink, more preferably in a form of a screen printable ink.

The ferroelectric ink composition according to the present invention can be prepared in several ways of mixing all ingredients together.

In one embodiment, the preparation of the ferroelectric ink composition according to the present invention comprises following steps:

1) pre-dissolving a binder into a solvent;

2) dispersing and/or dissolving an organic ferroelectric component into a solvent;

3) mixing solutions of steps 1 and 2 and mixing with speed mixer till homogenous mixture is formed; and

4) adding any optional ingredients and mixing till homogenous mixture is formed.

The ferroelectric ink composition according to the present invention can be used as a printable ink.

The ferroelectric ink composition according to the present invention can be applied onto a substrate by various techniques. Suitable techniques for use herein are for example screen printing, roll printing, roller coating, rotary screen printing, flexo printing, gravure coating and dispensing. Separate curing step is not required and is therefore optional, as the solvent evaporates during drying. A subsequent poling step is carried out after the drying, if piezoelectric response is desired. Preferred application method is screen printing, roll printing and rotary screen printing, and more preferably screen printing.

Non-limiting examples of suitable substrates to be used herein are any conductive materials or materials having conductive surface, for example metals, metal coated substrates such as silver ink coated substrate (PET for example), metallised substrates having for example gold sputtered on them.

The ferroelectric ink composition according to the present invention can be used as a sensor, an emitter or as a generator in an energy harvester.

A device, such as an emitter, a sensor or a generator for an energy harvester can be provided, wherein said device comprises a ferroelectric adhesive ink composition according the present invention between two conductive elements. A ferroelectric ink composition according to the present invention must be poled before use in the device.

In one preferred embodiment the ferroelectric ink composition according to the present invention comprises from 1 to 20% of a binder by weight of the total weight of the composition, 10 to 50% of a ferroelectric component by weight of the total weight of the composition and a solvent from 20% to 85% by weight of the total weight of the composition and wherein said ferroelectric component is in a ferroelectric phase.

In another preferred embodiment the ferroelectric ink composition according to the present invention comprises from 1.2 to 15% of a binder by weight of the total weight of the composition, 12 to 45% of a ferroelectric component by weight of the total weight of the composition and a solvent from 30% to 85% by weight of the total weight of the composition and wherein said ferroelectric component is in a ferroelectric phase.

Yet, in another preferred embodiment the ferroelectric ink composition according to the present invention comprises from 1.5 to 13.5% of a binder by weight of the total weight of the composition, 12.5 to 40% of a ferroelectric component by weight of the total weight of the composition and a solvent from 34% to 85% by weight of the total weight of the composition and wherein said ferroelectric component is in a ferroelectric phase.

### EXAMPLES

### Composition

The ferroelectric ink compositions in the examples comprise thermoplastic polyurethanes (Estane 5719 from Lubrizol) or phenoxy resins (PKHJ from IncChem) and they are dissolved in DBE-9 in a range between 10% and 50%, preferably 25% and Superglue3 from Henkel dissolved in 2-butoxyethyl acetate (BCA).

The ferroelectric ink compositions in the examples comprise organic ferroelectric components such as poly(vinylidene fluoride-trifluoroethylene) (P(VDF-TrFE) from Solvay.

Solvents for these systems comprise acetone, methyl ethyl ketone (MEK from Alfa Aesar), n,n-dimethylformamide (DMF from Alfa Aesar) and DBE-9 (from Sigma-Aldrich).

In order to prepare the ferroelectric inks, the ferroelectric components and inks are mixed together following different procedures depending on the chosen systems.

In table 1, detailed compositions of the examples 1-6 are shown.

TABLE 1

| | | | Ex. 2 | | | Ex. 4 | Ex. 5 | |
|---|---|---|---|---|---|---|---|---|
| | | | (com- | | | (com- | (com- | |
| Example/ | | Ex. | par- | | Ex. | para- | para- | |
| material | Ex. 1 | 1b | ative) | Ex. 3 | 3b | tive) | tive) | Ex. 6 |
| Binder | 0.2 g | 0.06 g | 0.2 g | | | | | |
| Estane | | | | | | | | |
| 5719 | | | | | | | | |
| Binder | | | | 0.2 g | 0.06 g | 0.2 g | | |
| PKHJ | | | | | | | | |
| Binder | | | | | | | | 0.25 g |
| superglue 3 | | | | | | | | |
| Solvent for | 0.65 g | 0.18 g | 0.65 g | 0.65 g | 0.18 g | 0.65 g | | |
| binder | | | | | | | | |
| DBE-9 | | | | | | | | |
| Organic | 0.5 g | 0.5 g | | 0.5 g | 0.5 g | | 0.5 g | 0.6 g |
| ferroelectric | | | | | | | | |
| material | | | | | | | | |
| P(VDF- | | | | | | | | |
| TrFE) | | | | | | | | |
| Solvent for | 2.80 g | 2.80 g | | 2.80 g | 2.80 g | | 2.80 g | |
| organic | | | | | | | | |
| ferroelectric | | | | | | | | |
| material | | | | | | | | |
| DBE-9 | | | | | | | | |
| Solvent | | | | | | | | 4.15 g |
| BCA | | | | | | | | |

In order to carry out ferroelectric characterization, the films are prepared as follows:

An organic ferroelectric component is dispersed and/or dissolved into a solvent and mixed together with ink (comprising a binder and a solvent for a binder). Films are prepared subsequently from the composition by bar-coating the composition with a coating gap of 200 μm. Film casting is made on a conductive substrate, metallized PET, which acts like an electrode for the ferroelectric characterization. After casting, the solvent is evaporated in two steps: first one at 70° C. for 15 minutes and a second one at 120° C. for 5 minutes. No curing step is required for these materials. When required, films are annealed at 130° C. for a certain time, depending on the system. Final film thickness is from 5 μm to 60 μm, preferably 15 μm. After the ferroelectric ink film is dried, upper electrodes are placed using a silver containing ink, by metal sputtering or using a conductive piece.

The key parameters for the sample preparation of each example is shown in table 2.

TABLE 2

| | Drying | | | | |
|---|---|---|---|---|---|
| Example/ | temper- | Drying | Annealing | Annealing | Film |
| preparation | ature | time | temperature | time | thickness |
| Example 1 | 70° C. | 15 min | 130° C. | 15 h | 15 μm |
| | 120° C. | 5 min | | | |
| Example 1b | 70° C. | 15 min | 130° C. | 15 h | 15 μm |
| | 120° C. | 5 min | | | |
| Example 2 | 70° C. | 15 min | — | — | 15 μm |
| (comparative) | 120° C. | 5 min | | | |
| Example 3 | 70° C. | 15 min | 130° C. | 15 h | 15 μm |
| | 120° C. | 5 min | | | |
| Example 3b | 70° C. | 15 min | 130° C. | 15 h | 15 μm |
| | 120° C. | 5 min | | | |
| Example 4 | 70° C. | 15 min | — | — | 15 μm |
| (comparative) | 120° C. | 5 min | | | |
| Example 5 | 70° C. | 15 min | 130° C. | 15 h | 10 μm |
| (comparative) | 120° C. | 5 min | | | |
| Example 6 | 70° C. | 15 min | 130° C. | 15 h | 15 μm |
| | 120° C. | 5 min | | | |

### Ferroelectric Characterization of Ferroelectric Inks

Ferroelectricity measurements consist on applying two cycles of an alternating external electric field at low frequency (freq.) to the sample. For that purpose, a high voltage AC power supply is needed. The electric field will polarize the sample generating some charge in the material, which is measured with a charge amplifier and visualized in an oscilloscope TDS200. The charge divided by the sample area gives the polarization value for each electric field applied. From this test, remnant polarization (Pr), coercive field (Ec) and electric field at breakdown (E break) are measured at a certain frequency.

### Poling of Ferroelectric Inks

After performing the ferroelectric characterization, the poling field (E poling) is determined considering it must be above the Ec. The material is then poled under E poling field for at least 60 seconds.

### d₃₃ Coefficient Measurement of Ferroelectric Inks

After poling is carried out, the measurement of the d₃₃ coefficient (piezoelectric strain coefficient) is performed using a Piezo d₃₃-meter PM-3500 (KCF Technologies, Inc). A low frequency oscillatory force (0.25N and 110 Hz) is applied to the sample and to a ceramic reference, generating some charge in both materials due to the piezoelectric effect. Knowing the d₃₃ of the reference, the d₃₃ of the sample is obtained by direct comparison

The results are summarized in table 3.

TABLE 3

| | Pr | Ec | Fre- | d₃₃ | E | | |
|---|---|---|---|---|---|---|---|
| | μC/ | V/ | quency | pC/ | poling | η | Thixotropic |
| Example | cm² | μm | Hz | N | V/μm | (Pa · s) | Index |
| Example 1 | 3.5 | 85 | 1 | 9.8 | 100 | 7.67 | 2.55 |
| Example 1b | 6.0 | 75 | 1 | 15.2 | 100 | 4.40 | 1.06 |
| Example 2 | — | — | 1 | | — | 6.31 | 1.01 |
| comparative | | | | | | | |
| Example 3 | 3.5 | 120 | 1 | 9.6 | 130 | 3.60 | 1.18 |
| Example 3b | 4.3 | 65 | 1 | 15.8 | 90 | 2.84 | 1.04 |
| Example 4 | — | — | 1 | | — | 8.06 | 1.02 |
| comparative | | | | | | | |
| Example 5 | 7.0 | 75 | 1 | 17.5 | 100 | 4.23 | 1.41 |
| comparative | | | | | | | |
| Example 6 | 6.3 | 80 | 1 | 18 | 135 | 0.35 | 1.3 |

The ferroelectric ink compositions according to the present invention can be used to form films which provide good adhesion to the selected substrates (unlike fluoropolymers on their own) and good ferroelectric response.

What is claimed is:

1. A ferroelectric ink composition comprising
a) a binder;
b) an organic ferroelectric component; and
c) a solvent,
wherein said ferroelectric component is in a ferroelectric phase.

2. A ferroelectric ink composition according to claim 1, wherein said binder is selected from the group consisting of thermoplastic polyurethanes, polyesters, polyacrylates, polysiloxanes, halogenated vinyl or vinylidene polymers, polyamide copolymers, phenoxy resins, polyethers, polyketones, polyvinyl butyral, polyvinyl pyrrolidone, polyacrylates, polycyanoacrylates and mixtures thereof.

3. A ferroelectric ink composition according to claim 1, wherein composition comprises a binder from 1% to 20% by weight of the total weight of the composition, preferably from 1.2% to 15%, and more preferably from 1.5% to 13.5%.

4. A ferroelectric ink composition according to claim 1, wherein said organic ferroelectric component is selected from the group consisting of polyvinylidene difluoride (PVDF), polyvinylidene difluoride trifluoroethylene (P(VDF-TrFE)), polyvinylidene difluoride hexafluoropropylene (P(VDF-HFP)), polyvinylidene difluoride trifluoroethylene chlorofluoroethylene (P(VDF-TrFE-CFE)) 2-methylbenzimidazole, diisopropylammonium chloride, diisopropylammonium bromide, croconic acid, TTF-PMDI salts and mixtures thereof, preferably said ferroelectric component is polyvinylidene difluoride trifluoroethylene (P(VDF-TrFE)).

5. A ferroelectric ink composition according to claim 1, wherein composition comprises an organic ferroelectric component from 10% to 50% by weight of the total weight of the composition, preferably from 12% to 45%, and more preferably from 12.5% to 40%.

6. A ferroelectric ink composition according to claim 1, wherein said solvent is selected from the group consisting of alcohols, ketones, esters, glycol esters, glycol ethers, ethers, amides, organosulfur compounds and mixtures thereof, preferably selected from the group consisting of acetone, amyl acetate, ethyl 3-ethoxypropionate (EEP), diethyl glycol, monoethyl ether, diethylene glycol dimethylene ether, carbitol, carbitol acetate, butyl carbitol, methyl ethyl ketone (MEK), cyclohexanone, diethylene glycol monoethyl ether acetate, ethylene glycol monobutyl ether acetate, ethylene glycol monobutyl ether, dipropylene glycol monomethyl ether, dipropylene glycol dimethyl ether, mixture of dimethyl glutarate and dimethyl succinate (DBE-9), N,N-dimethylformamide, dimethylacetamide, dimethylsulfoxide, water, ethanol and mixtures thereof. More preferably said solvent is selected from the group consisting of acetone, mixture of dimethyl glutarate and dimethyl succinate (DBE-9), ethylene glycol monobutyl ether acetate, methylethyl ketone (MEK) and mixtures thereof.

7. A ferroelectric ink composition according to claim 1, wherein composition comprises a solvent from 20% to 85% by weight of the total weight of the composition, preferably from 30% to 85%, and more preferably from 34% to 85%.

8. A ferroelectric ink according to claim 1, wherein said composition has a viscosity from 1 to 30 Pas (10 s⁻¹) measured on a rheometer AR 2000 at constant shear rate with 40 mm plate-plate configuration (0.5 mm gap, 180 sec, at 25° C.), preferably from 2 to 25 Pas (10 s⁻¹) and more preferably from 3 to 20 Pas (10 s⁻¹).

9. A ferroelectric ink according to claim 1, wherein said composition has a solid content from 5% to 35%, preferably from 10% to 30% and more preferably from 15% to 25%.

10. Use of a ferroelectric ink composition according to claim 1 as a printable ink.

11. Use of a ferroelectric ink composition according to claim 1 as a sensor, an emitter or as a generator in an energy harvester.

12. A device comprising a ferroelectric adhesive ink composition according to claim 1 between two conductive elements.
